(19) United States
(12) Patent Application Publication
(10) Pub. No.: US 2020/0213563 A1
(43) Pub. Date: Jul. 2, 2020

(54) BOILER INSPECTION DEVICE

(71) Applicant: TEG Energy Group, Inc., Brooklyn, NY (US)

(72) Inventors: Peter G. Morice, Brooklyn, NY (US); Clayton G. Baumgart, Brooklyn, NY (US); Andrew F. Crevier, Flintstone, MD (US); Robert R. Kydd, Manhattan, NY (US); Mark S. Hellinger, Miami, FL (US)

(73) Assignee: TEG Energy Group, Inc., Brooklyn, NY (US)

(21) Appl. No.: 16/720,946

(22) Filed: Dec. 19, 2019

Related U.S. Application Data
(60) Provisional application No. 62/785,747, filed on Dec. 28, 2018.

(51) Int. Cl. H04N 7/18; G01N 21/88; H04N 5/225; H04N 5/232; H04N 5/445

(52) U.S. Cl. CPC H04N 7/183; G01N 21/8851; H04N 5/2253; H04N 5/2256; G01N 2021/8893; H04N 5/44504; G01N 2201/02; G01N 2201/102; H04N 5/232

(57) ABSTRACT

An inspection device facilitates inspection of the interior of a boiler, such as the burner front, while the operator remains stationed outside the boiler. The inspection device includes a camera mounted to a distal end of a shaft sized to be received through a port formed in the boiler wall. The camera is pivotable between a low-profile stowed position, which allows passage through the inspection port, and a deployed position which allows the camera to gain a full and complete picture of the interior of the boiler. A proximal control may be provided to allow the operator to pivot the camera between the stowed and deployed positions for ingress, use and egress of the camera.

### TECHNICAL FIELD

The present disclosure relates generally to inspection devices and, more particularly, to remote-controlled inspection devices suitable for inspection of the interior of a steam boiler.

### BACKGROUND

Large scale industrial boilers are used in the creation of steam for power generation. For oil and natural gas fired boilers, ports are used to inject oil or natural gas into a combustion chamber. The fuel is mixed with air and combusted to convert water to steam. The steam may then be directly sent out to users for heating or cooling applications, or may be used to drive turbines for electrical power production.

For utility-scale power generation, oil or gas burner fronts may be several stories above ground level and may be connected to boiler structures which rise several additional stories above the burner fronts. The burner fronts must be periodically inspected to ensure safe and efficient boiler operation. Such inspections may occur manually, with a worker entering the interior of the boiler to visually inspect the burners and report on their condition. This manual inspection may take several hours, and requires the construction of scaffolding along with various safety measures.

Because inspections require a complete shutdown of the boiler, it is desirable to accomplish inspections as quickly as possible. In addition, enhancing worker safety is always a priority in power plant operations.

### SUMMARY OF THE DISCLOSURE

The present disclosure provides an inspection device which facilitates inspection of the interior of a boiler, such as the burner front, while the operator remains stationed outside the boiler. The inspection device includes a camera mounted to a distal end of a shaft sized to be received through a port formed in the boiler wall. The camera is pivotable between a low-profile stowed position, which allows passage through the inspection port, and a deployed position which allows the camera to gain a full and complete picture of the interior of the boiler. A proximal control may be provided to allow the operator to pivot the camera between the stowed and deployed positions for ingress, use and egress of the camera.

In one form thereof, the present disclosure provides an inspection device including a shaft having a proximal portion and an opposing distal portion with a longitudinal axis extending therebetween, a camera having a camera lens, the camera coupled to the distal portion of the shaft, the camera configurable between a stowed position and a deployed position; and a light coupled to the camera and aimed in the same direction as the lens. The camera and the light cooperate to define a stowed radial extent when the camera is in the stowed position and a deployed radial extent when the camera is in the deployed position, the stowed radial extent less than the deployed radial extent.

In another form thereof, the present disclosure provides a method of inspecting the interior of a boiler, the method including inserting a distal portion of an inspection device into a port formed in a wall the boiler, then deploying a camera and a light from a stowed position, in which the camera and light are aligned with the inspection device, into a deployed position, in which the camera and light face backwardly toward a the wall of the boiler. The method further includes activating the camera and the light to generate an image of a burner assembly, the image viewable from outside the boiler.

The above-mentioned and other features of the invention and the manner of obtaining them will become more apparent and the invention itself will be better understood by reference to the following description of exemplary embodiments of the invention taken in conjunction with the accompanying drawings.

### BRIEF DESCRIPTION OF THE DRAWINGS

The foregoing aspects and many of the intended advantages of this invention will become more readily appreciated as the same becomes better understood by reference to the following detailed description when taken in conjunction with the accompanying drawings.

FIG. 1 is a schematic, side elevation view of a boiler, in which an operator is inspecting a burner front from the exterior in accordance with the present disclosure;

FIG. 2 is a side elevation view of the burner front shown in FIG. 1, in which the operator is inspecting a burner using an inspection device made in accordance with the present disclosure;

FIG. 3 is a sample image of a burner obtainable using the inspection device of FIG. 2, and further including image processing in accordance with the present disclosure;

FIG. 4 is a perspective view of the inspection device shown in FIG. 2, showing a distal camera in both deployed and stowed positions;

FIG. 5 is an enlarged perspective view of the distal camera assembly shown in FIG. 4, shown in its stowed position;

FIG. 6 is an enlarged perspective view of the distal camera assembly shown in FIG. 4, shown in the deployed position;

FIG. 7 is an exploded view the camera assembly of the inspection device shown in FIG. 2; and

FIG. 8 is a side elevation, partial section view of the inspection device shown in FIG. 4, in which the section is taken along section line 8 of FIG. 4.

Corresponding reference characters indicate corresponding parts throughout the several views. Although the drawings represent embodiments of various features and components according to the present disclosure, the drawings are not necessarily to scale and certain features may be exaggerated in order to better illustrate and explain the present disclosure. The exemplifications set out herein illustrate embodiments of the invention, and such exemplifications are not to be construed as limiting the scope of the invention in any manner.

### DETAILED DESCRIPTION OF THE DRAWINGS

For the purposes of promoting an understanding of the principals of the invention, reference will now be made to the embodiments illustrated in the drawings, which are described below. The embodiments disclosed below are not intended to be exhaustive or limit the invention to the precise form disclosed in the following detailed description. Rather, the embodiments are chosen and described so that others skilled in the art may utilize their teachings. It will be understood that no limitation of the scope of the invention is thereby intended. The invention includes any alterations and further modifications in the illustrative devices and described methods and further applications of the principles of the invention which would normally occur to one skilled in the art to which the invention relates.

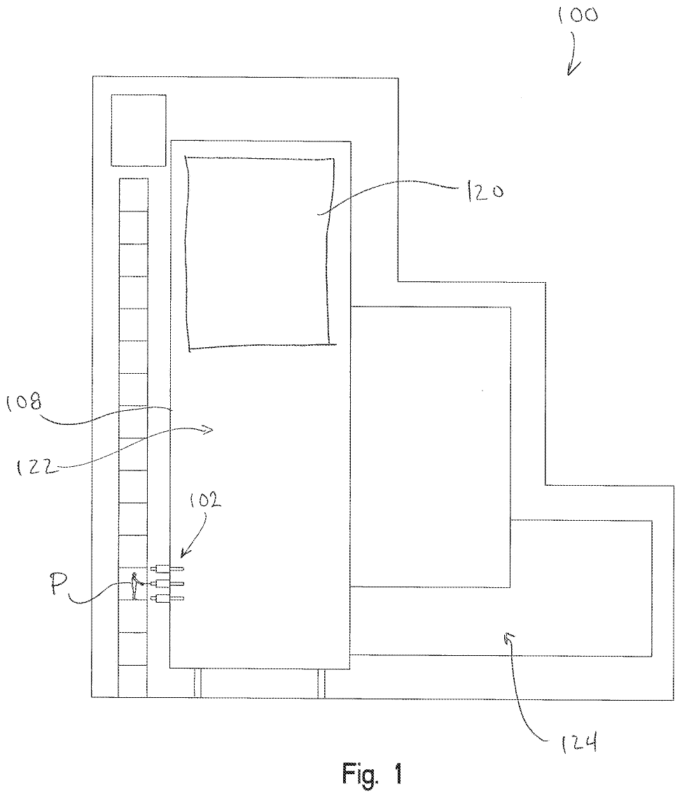

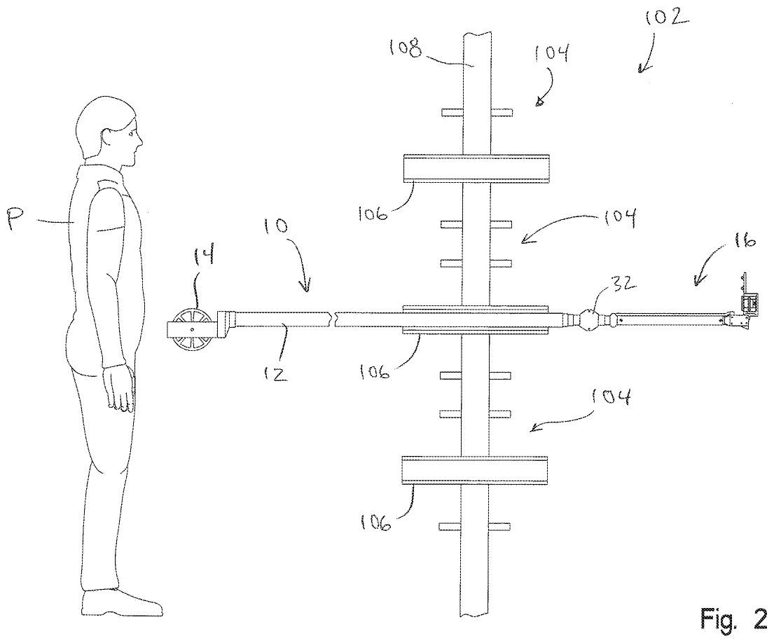

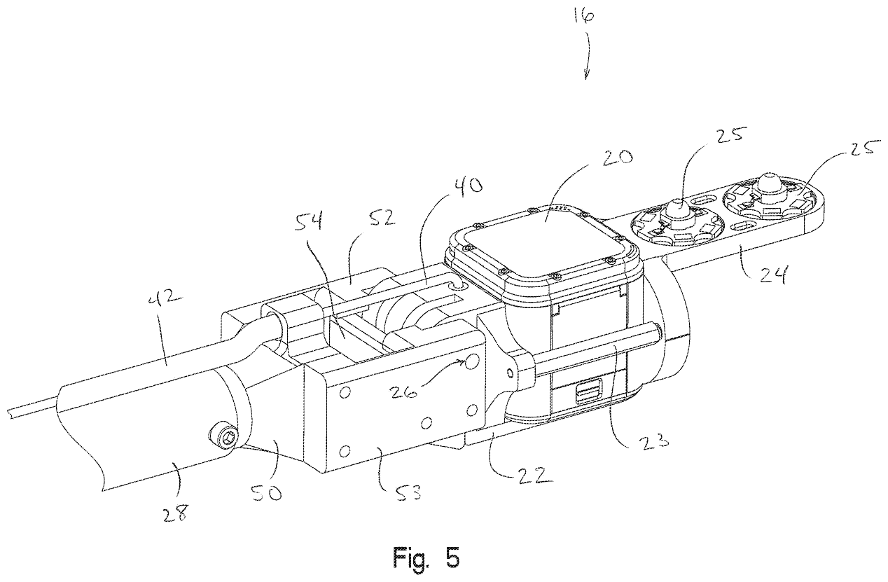

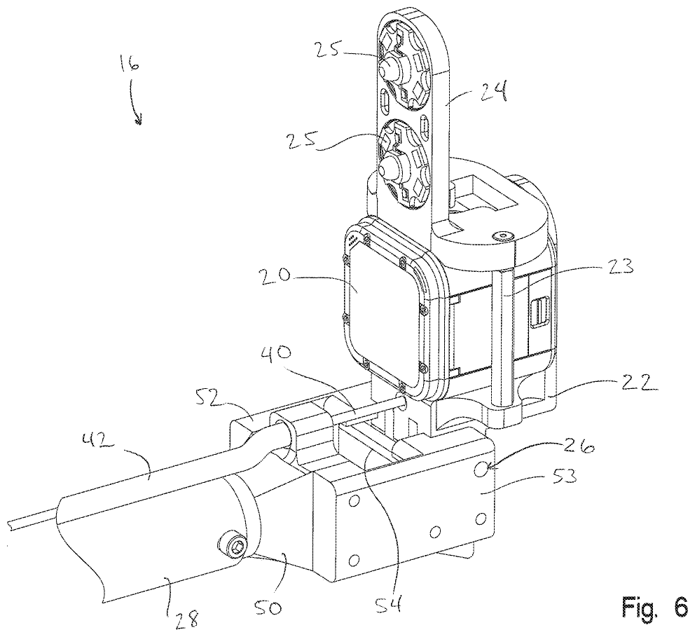

The present disclosure provides inspection device 10, shown in FIG. 2, which is configured for use in connection with inspection of boilers for utility scale power and steam generation, such as boiler 100 shown in FIG. 1. As described in detail below, inspection device 10 includes camera assembly 16 which can be configured in a radially-compact, stowed position (FIG. 5). In the stowed position, camera 20 and its associated structures are aligned with the longitudinal axis of inspection device 10 and define a radial extent with respect to the longitudinal axis that is small enough to pass unimpeded through an existing gas or oil port 106 (FIG. 2). Once camera assembly 16 is received within the interior of boiler 100, reel 14 may be actuated to deploy camera 20 into a deployed position (FIG. 6). In the deployed position shown in FIG. 2, camera 20 and its associated structures face the burner front 102 and, when activated, can be used for remote visual inspection of burners 104. In this configuration, camera 20 and its associated structures define a radial extent with respect to longitudinal axis of inspection device 10 which is substantially larger than the size of the passageway through port 106 (FIG. 2), but camera assembly 16 may be reconfigured to the stowed position for withdrawal of inspection device 10 when imaging is complete.

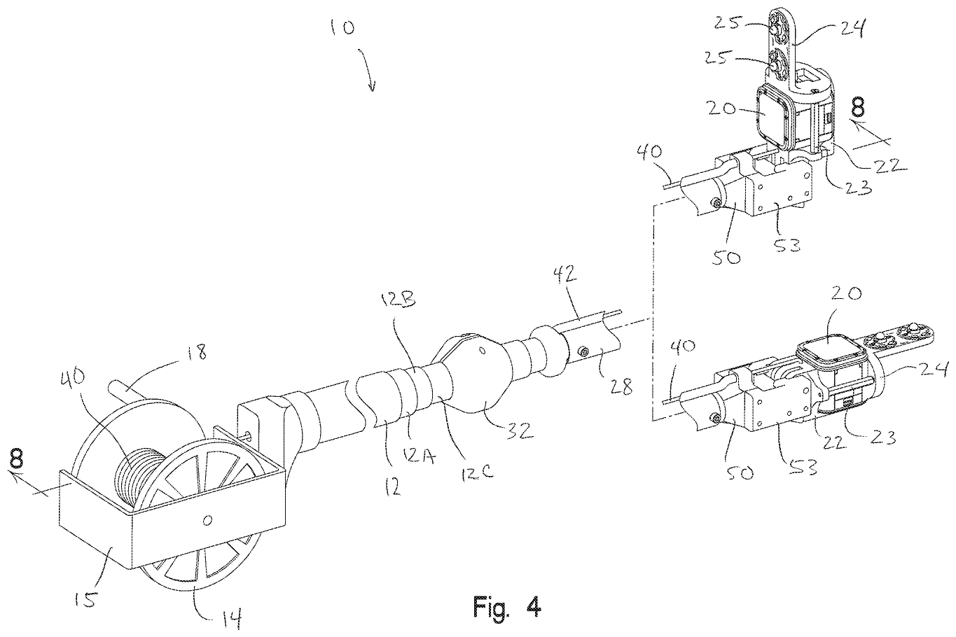

Turning now to FIG. 4, a perspective view of inspection device 10 is shown with shaft lengths abbreviated to better illustrate individual components. The proximal portion of inspection device 10 includes reel 14 rotatably supported by reel housing 15. A quantity of cable 40 is wound on reel 14 to accommodate the length adjustability of telescoping shaft 12 (further discussed below). Reel handle 18 facilitates the manual winding or unwinding of cable 40, though reel 14 may also be motorized. A proximal portion (e.g., the proximal terminal axial end) of telescoping shaft 12 is connected to reel housing 15 and has cable 40 passing through the shaft interior. In the illustrated embodiment, shaft 12 includes additional telescoping shaft components 12A, 12B and 12C which allow the affective length of telescoping shaft 12 to be configured to various lengths. For example, telescoping shaft 12 may be about 4 to 6 feet long when fully compacted (as shown), but may be extended up to 156 additional inches when fully extended. This adjustability allows imaging in different scales by facilitating adjustment of the distance of camera 20 from the imaged surface, and also allows inspection device 10 to be used in various boiler configurations without modification. In an exemplary embodiment, shaft 12 may include length markings at fixed intervals to indicate to the user the extended length of the shaft. Similarly, the rotation angle of the shaft and camera assembly may also be marked to provide an indication of the rotational deviation of camera 20 from its upright position (as shown, e.g., in FIG. 2).

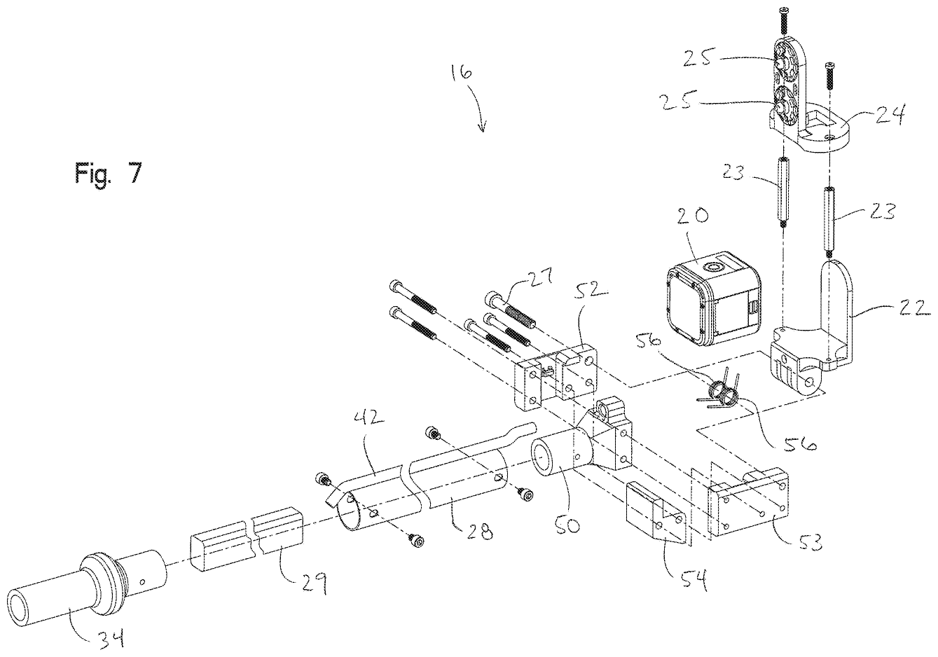

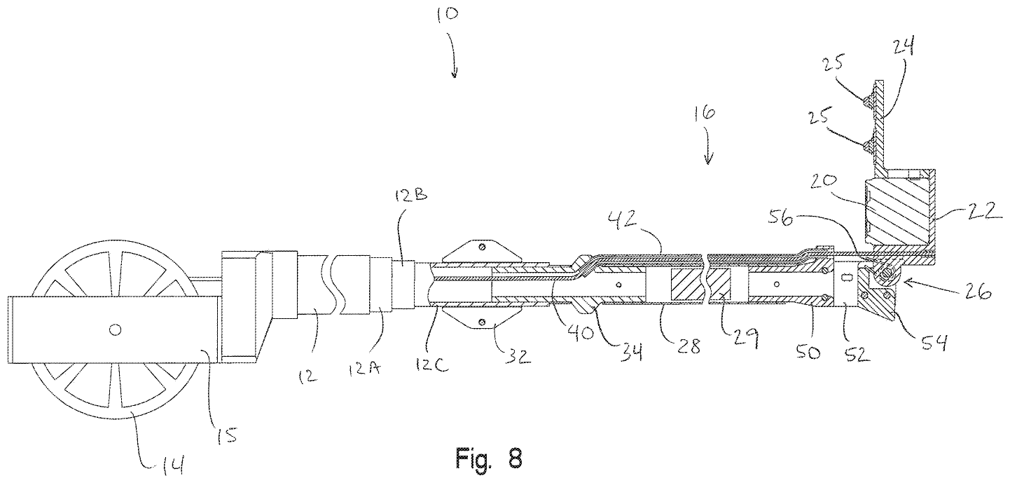

Referring to FIG. 2, the distal portion of inspection device 10 is sized and configured to pass through port 106 in boiler wall 108, where camera assembly 16 can then operated by proximal control from the exterior side of boiler wall 108. The components of camera assembly 16 are shown in detail in the exploded view of FIG. 7 as well as the sectioned portion of FIG. 8.

Camera assembly 16 is removably fixed to a distal portion (e.g., the distal terminal axial end) of telescoping shaft 12. In the illustrated embodiment, junction component 34 is configured to be received within the open distal end of component 12C of shaft 12 and may be fixed thereto, such as by adhesive, welding, mechanical fasteners, or any other suitable method. Battery housing 28 is removably attached to the opposite (i.e., distal) end of junction component 34, such as by fasteners as shown in FIG. 7. Battery housing 28 receives and houses battery 29 which provides electrical power to camera 20 and/or lights 25 as described further below.

Distal base component 50 is removably attached to the opposite (i.e., distal) end of battery housing 28 and serves as an attachment point for joiner plates 52, 53. In the illustrative embodiment of FIG. 7, a proximal portion of plates 52, 53 are fixed to base component 50 by threaded fasteners as shown. Pivot 26 is formed around axle 27, which is illustratively a threaded fastener passing through joiner plate 52, through a pivot portion of camera mount plate 22, and into joiner plate 53 where axle 27 is threadably connected. Pivot connection 26 allows camera mount plate 22 to rotate about pivot axle 27 between the stowed configuration of FIG. 5 and the deployed configuration of FIG. 6. Pivot block 54 is attached to a distal portion of plates 52, 53, and provides a spring seat surface for one leg of each torsion spring 56, as best shown in FIG. 8. The other leg of each torsion spring 56 bears upon respective slots formed within the pivot portion of camera mount plate 22 (FIG. 7). This configuration of torsion springs 56 urges camera mount plate 22 (together with camera 20 and lights 25) into its stowed configuration shown in FIG. 5. Torsion springs 56 will retain camera mount plate in the stowed position in the absence of a countervailing force from cable 40, as described below. Other biasing elements may be used to bias camera assembly 16 into a “normally stowed” configuration as required or desired for a particular application in accordance with the present disclosure.

Turning again to FIG. 8, a distal portion of cable 40 passes through cable housing 42, which is fixed to the exterior surface of battery housing 28. Cable housing 42 directs cable 40 to a distal terminal connection with camera mount plate 22. This terminal connection is radially spaced from the axis of pivot 26, such that a force applied by tension in cable 40 creates a moment urging camera mount plate into its deployed position (FIG. 6). In the illustrated embodiment, this tension in cable 40 is generated by actuation of reel 14 (FIG. 4).

In particular, sufficient tension in cable 40 over comes the biasing force of springs 56 and causes camera mount plate 22 to pivot upwardly against the biasing force. As this pivoting occurs, springs 56 actuate and accumulate torsional energy. Once camera mount plate 22 has rotated by 90 degrees, camera 20 is considered to be in a fully deployed configuration in which the lens or other viewing surface of camera 20 looks “backwardly” along the longitudinal surface of inspection device 10 and, when used in boiler 100, toward burner front 102 (FIG. 2). In some instances, camera mount plate 22 and camera 20 may be rotated by less than 90 degrees to a deployed position greater than zero degrees (i.e. fully stowed). For purposes of the present disclosure, any position in which camera 20 and camera mount plate 22 have a radial profile larger than the stowed position (FIG. 5) may be considered a “deployed” position, if not a “fully” deployed position corresponding to a full 90-degree rotation.

In the illustrated embodiment of FIGS. 4-8, camera 20 is retained upon camera mount plate 22 by lighting bracket 24, which also provides for attachment of lights 25 to camera assembly 16. In particular, opposing surfaces of camera 20 abut respective surfaces of camera mount plate 22 and lighting bracket 24, and standoffs 23 are connected to plate 22 to bracket 24 and then tightened to “squeeze” camera 20 therebetween. A rear surface of camera 20, which is opposite the camera lens shown in FIGS. 5 and 6, may also abut an upstanding portion of mount plate 22 for additional retention security.

In an exemplary embodiment, camera 20 may be a high definition wireless (“Wi-Fi”) camera capable of streaming high definition videos and photographs back to a mobile device or other viewing computer to facilitate “real time” viewing and capture of images. This real time viewing modality also allows for real time mechanical adjustments to burner 104 (as further described herein), with immediate visual feedback as to the nature and extent of the adjustments being made. Of course, camera 20 may also take various other forms as required or desired for a particular application, including cameras which simply collect and record image data locally for later download and viewing. In one exemplary embodiment, camera 20 is a “Hero” model, such as a Hero Session or Hero5 Session, available from GoPro, Inc. of San Mateo, Calif., USA. Generally speaking, a digital camera with a resolution of at least 4 megapixels, 6 megapixels, 8 megapixels or 10 megapixels (or their analog equivalents) is suitable for use in connection with inspection device 10. For video capture, a camera capable of high-definition video, such as video satisfying the 4K standard (e.g., a resolution of 3840×2160 pixels) may be used. The selection of resolution may be a function of light intensity, with lower resolution (e.g., 6-8 megapixels) used for lower-light images and vice-versa. The necessary quality of the image may also be considered depending on the level of detail required for a particular application.

Lights 25 are fixed to lighting bracket 24 such that the lights 25 are aimed in the same direction as the lens of camera 20. Thus, when camera 20 is located within the dark interior of boiler 100, lights 25 may be activated to illuminate the surface to be viewed. In the illustrative embodiment, lights 25 are an arrangement of LEDs received within correspondingly sized recesses formed in lighting bracket 24.

As shown in FIG. 8, tapered guides 32 may be received on the exterior surface of the distal end of telescoping shaft component 12C. Guide 32 has tapered surfaces along is distal and proximal ends which aid in the insertion and withdrawal of inspection device 10 as it passes through port 106. Similarly, junction component 34 may include a radially expanded and tapered portion spanning the junction between the distal terminal axial end of shaft component 12C and the adjacent proximal axial terminal end of battery housing 28, thereby eliminating any shoulders or edges that might otherwise catch on an edge of port 106.

Turning again to FIG. 2, operator P may use and control inspection device 10 from the exterior side of boiler wall 108 to view and evaluate burners 104 located in the burner front 102 of boiler 100 (FIG. 1). In an exemplary application, operator P occupies preexisting operator space in boiler 100 used for, for example, oil or gas injection devices, damper control actuators, and other tools and devices used in the operation of burner front 102. Burner front 102 is located within a larger boiler construct including furnace 122, which uses burners 104 to heat water contained in the boiler tubes into steam for any steam users supplied by the boiler. Sections of the boiler for the purpose of heat transfer are schematically illustrated in FIG. 1 as heat transfer unit 120, which may include economizers, superheaters and reheaters. Boiler 100 may further include mechanical components 124 used in the operation and management of boiler 100, such as recirculation fans, forced draft fans, air heaters, and gas outlets.

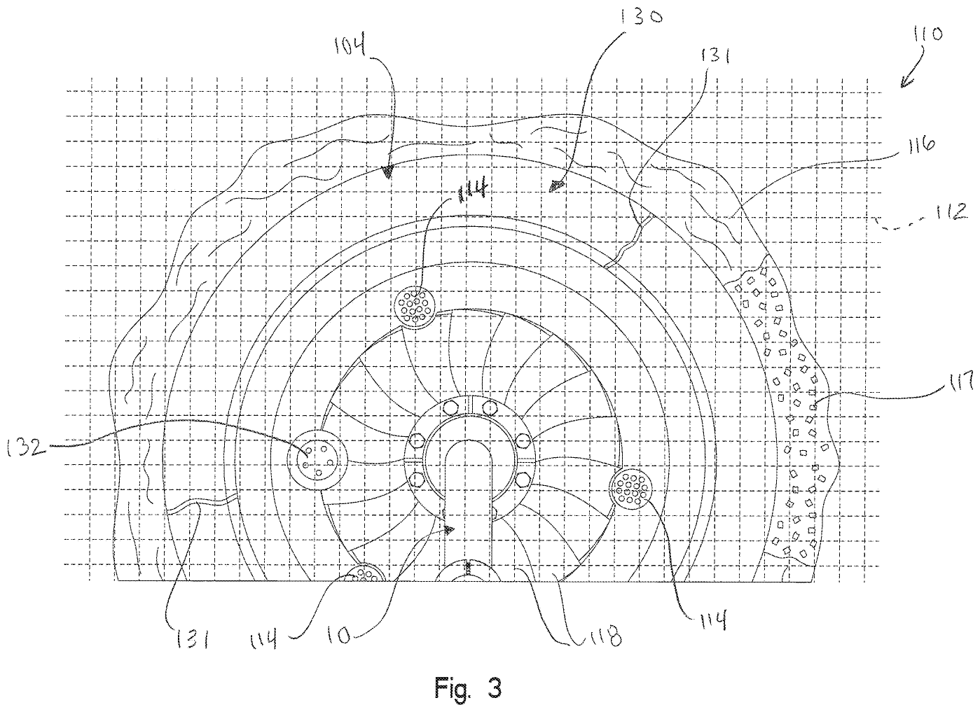

In operation, operator P starts with inspection device 10 having camera assembly 16 in a stowed configuration (FIG. 5). As noted above, this generally aligns camera 20, lights 25 and their associated components with the longitudinal axis of telescoping shaft 12. In particular, the radial boundaries of camera assembly 16 in the stowed configuration may be commensurate with, or less than, the radial extent of tapered guide 32 and also small enough to pass unimpeded through the interior bore of oil port 106 (FIG. 2) after removal of the oil injector which normally occupies the port 106. Alternatively, camera assembly 16 may be inserted through any other suitably sized opening in burner front 102 and/or boiler wall 108, such as in gas conduits designed to feed gas spuds (such as, e.g., gas conduits for spuds 114 shown in FIG. 3 and described in further detail herein). In one exemplary embodiment, port 106 or other suitable conduit may have an interior diameter of 2.05-2.40 inches and the radial extent of camera assembly 16 in the stowed configuration may be circumscribed by a circle having a diameter of less than 2 inches, such as 1.98 inches or less.

Operator P aligns the longitudinal axis of inspection device 10 with the longitudinal axis of port 106 and inserts camera assembly 16 into the interior bore of port 106. Operator P may then expand respective sections 12A, 12B and/or 12C to extend those portions through port 106, as necessary, locking each section in place. In an exemplary embodiment, shaft 12 includes collars at the end of each section 12A, 12B and 12C. Each collar can be tightened to compress the exterior of the section and thereby lock the neighboring sections in relative to one another. At the distal end of the distal section 12C of telescoping shaft 12, a collar can be similarly used to lock components 34 and 12C together. In one particular embodiment, shaft 12 may be the Infinitube UL Extra Large, which is part number 45804 available from Rock West Composites. In other embodiments, alternative designs may be used such as friction locking extendable rods, or any other suitable locking mechanism. This extendible design may be desired, for example, for boilers having long ports 106 or situations where it is desired for camera 20 and lights 25 to be a relatively larger distance away from burners 104 for a wide-perspective view. If shaft 12 is extended, cable 40 is allowed to feed freely from reel 14 as the extension is made.

Once any desired extension is complete (as indicated, for example, by markings on shaft 12 as noted above), operator P pushes on the proximal portion of telescoping shaft 12 and/or reel 14 to place camera assembly 16 into a final desired position fully within the interior of boiler 100. Optionally, operator P may use tapered guide 32 as a contacting surface with the adjacent interior side wall of port 106 to aid in insertion of camera assembly 16 into the interior of boiler 100.

With camera assembly 16 fully deployed to the interior of boiler 100, operator P may tension cable 40 (FIG. 6) by rotating reel 14 (FIGS. 2 and 8). As noted above, sufficient tension in cable 40 causes camera 20, lights 25 and their associated structures to rotate about pivot 26 away from the stowed configuration (FIG. 5) toward a fully deployed configuration (FIG. 6). Operator P may choose to “fully” deploy camera 20 and lights 25 by rotating these components by a full 90 degrees, but deployment may also use a lesser rotation depending on the particular view and perspective desired. In an exemplary embodiment, operator P will have switched on electrical power to camera 20 and/or lights 25 from their respective battery or batteries (e.g., battery 29 as shown in FIGS. 7 and 8), prior to insertion of inspection device 10, though it is also contemplated that a remote switch could be provided for toggling power on and off after deployment. In the illustrated embodiment, battery 29 powers lights 25 while camera 20 has its own internal battery (not shown), and both are locally switched to avoid cabling or other power transition across the length of shaft 12. Upon activation, camera 20 begins collecting images illuminated by lights 25.

FIG. 3 shows a sample image 110 which may be collected by camera 20 and illuminated by lights 25 during use of inspection device 10. As shown, a portion of shaft 12 of inspection device 10 is visible in the image, as camera 20 is oriented in a “back facing” configuration in which the lens of camera 20 is facing toward the proximal portion of inspection device 10 and toward operator P (FIG. 2). This allows image 110 to illustrate portions of burner 104. Operator P and/or another viewer may conduct a real-time evaluation of image 110 for data of interest, such as data pertinent to the functioning and condition of burner 104. Data may also be recorded as video and/or image stills for later reference and analysis.

For example, the condition and orientation of gas spuds 114 may be evaluated, to ensure that their angular orientation is within desired tolerances and to search for any impingement of gas spuds 114 on adjacent structures. Similarly, the condition, orientation and relative positioning of igniter 132 may be assessed. Further, the condition and orientation of dampers 118 may be evaluated, and their function may be assessed by activating dampers 118 while viewing and/or recording real-time video gathered by camera 20. Refractory material 116 may also be inspected, and the extent and nature of any damage 117 to refractory material 116 may be assessed. The size, location and nature of any cracks 131 in burner throat 130 may also be discovered and evaluated.

In an exemplary application, a scaled inspection grid 112 may be superimposed upon image 110 to provide for measurement and relative positioning of various features of interest, including those mentioned above. Moreover, because camera 20 is a high-definition unit capable of capturing undistorted images illuminated by high intensity lights 25, image 110 can provide an accurate and to-scale depiction of burner 104 such that accurate measurements may be obtained using inspection grid 112 or other post-processing software, including CAD software. By contrast, certain other remote camera devices, such as fiber scopes and other small cameras, produce images which are distorted in that the images do not have proportions (e.g., “scale”) that are the same as the actual device being imaged.

FIG. 3 shows a portion of burner 104 but excludes another portion below shaft 12. To view the other portions of burner 104, operator P may rotate inspection device 10 about its longitudinal axis, thereby rotating camera assembly 16 and allowing camera 20 to capture images from any rotational orientation relative to burner 104. In this way, the entirety of burner 104 may be inspected and evaluated using the present method in conjunction with inspection device 10. In one exemplary embodiment, a high-definition still image may be captured at each of four equally-spaced rotational orientations separated by 90 degrees. These four images may then be stitched together, either manually or using commercially available or proprietary digital methods, to create a single accurate image of the entire burner 104.

Inspection device 10 may be utilized for each and every burner 104 in a burner front 102. When imaging of one burner 104 is completed, inspection device is simply withdrawn from its ports 106 and deployed in alternative ports 106 to allow for inspection of additional burners. In this way, a large number of burners, such as a dozen burners or more, may be inspected serially within a short amount of time.

When a particular imaging operation is complete, operator P may allow camera assembly 16 to be returned to its stowed configuration by slacking cable 40 (FIG. 8) through reverse rotation of reel 14. In an exemplary embodiment, reel 14 may be locked in place, such as with a ratchet or friction feature, for hands-free retention of camera assembly 16 in the deployed configuration. This locking feature may therefore be released prior to reverse rotation of reel 14. As described above, torsion springs 56 urge camera 20, lights 25 and their associated structures to return to the stowed position once tension in cable 40 is released. Camera assembly 16 may then be withdrawn from port 106.

Inspection device 10 may also be disassembled for easy transport and storage. In particular, reel 14 may be removed from telescoping shaft 12, telescoping shaft 12 may itself be fully compacted, and camera assembly 16 may also be removed from shaft 12. Cable 40 may be reeled in to take up any slack from compacting telescoping shaft 12. If desired, cable 40 can be completely disconnected from camera mount plate 22 (FIG. 8) and reeled to be completely contained in reel 14. In an exemplary embodiment, cable 40 includes a quick-connect mechanism located within battery shaft 28 which allows operator P to selectively join or disconnect the distal portion of cable 40 from the proximal portion. The quick-connect mechanism allows the distal portion of cable 40 to remain connected to camera mount plate 22 during disassembly of inspection device 10, facilitating quick removal of camera assembly 16 from the shaft 12. The remaining proximal length of cable 40, up to the point of the quick-connect mechanism in housing 28, can then be reeled back to reel 14.

Use of inspection device 10 allows for comprehensive inspection of the interior of boiler 100 while avoiding the cost and risk associated with an operator physically entering the boiler. Moreover, camera 20 works in conjunction with lights 25 to provide a properly scaled image 110 (FIG. 3), as described above. This allows an operator or other decision maker to see the size and proportion of burner parts and assess the extent and location of any damage or misalignment.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practices in the art to which this invention pertains.

1. An inspection device comprising:
a shaft having a proximal portion and an opposing distal portion with a longitudinal axis extending therebetween;
a camera having a camera lens, the camera coupled to the distal portion of the shaft, the camera configurable between a stowed position and a deployed position; and
a light coupled to the camera and aimed in the same direction as the camera lens,
the camera and the light cooperating to define a stowed radial extent when the camera is in the stowed position and a deployed radial extent when the camera is in the deployed position, the stowed radial extent less than the deployed radial extent.

2. The inspection device of claim 1, wherein the camera and the light are pivotably connected to distal portion of the shaft about a pivot, the device further comprising:
a reel connected to the proximal portion of the shaft;
a cable extending from the reel to the camera and the light, the cable joined to the camera and the light at a point spaced from the pivot such that a tension in the cable causes the camera and the light to rotate about the pivot from the stowed position toward the deployed position.

3. The inspection device of claim 2, further comprising at least one biasing element operably disposed between the camera and the distal portion of the shaft, the biasing element urging the camera and the light toward the stowed position.

4. The inspection device of claim 2, wherein the camera and the light are rotatable by at least 90 degrees between the stowed position and the deployed position.

5. A method of inspecting the interior of a boiler, the method comprising:
inserting a distal portion of an inspection device into a port formed in a wall of the boiler;
after the step of inserting, deploying a camera and a light from a stowed position, in which the camera and the light are aligned with the inspection device, into a deployed position, in which the camera and the light face backwardly toward the wall of the boiler; and
activating the camera and the light to generate an image of a burner assembly, the image viewable from outside the boiler.

6. The method of claim 5, wherein the image is displayed on a computer display.

7. The method of claim 6, further comprising superimposing a scale grid over the image to facilitate measurements from the image.

8. The method of claim 5, further comprising:
reconfiguring the camera and the light to the stowed position;
after the step of reconfiguring, withdrawing the camera and the light from the boiler through the port.
